(19) United States
(12) Patent Application Publication
(10) Pub. No.: US 2009/0134043 A1
(43) Pub. Date: May 28, 2009

(54) NON-BIOFOULING, UNIVERSAL REDOX ELECTRODE AND MEASUREMENT SYSTEM

(76) Inventors: Kevin Ward, Richmond, VA (US); Fred Hawkridge, Richmond, VA (US); Sean Brahim, Camarillo, CA (US); Kelvin L. Lewis, Chester, VA (US); Melissa C. Rhoten, Amelia, VA (US)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 12/093,018

(22) PCT Filed: Nov. 13, 2006
(86) PCT No.: PCT/US06/60821

§ 371 Date: Sep. 30, 2008

Related U.S. Application Data
(60) Provisional application No. 60/735,202, filed on Nov. 10, 2005.

(51) Int. Cl. G01N 27/26

(52) U.S. Cl. 205/792; 204/435; 204/400

(57) ABSTRACT

A universal reduction-oxidation (redox) electrode allows for the temporal measurement of the redox potential of a variety of biological or environmental fluids or tissues, and assists in the diagnosis of matters related to health and disease. The electrode is made from gold which is derivatized with an electron transport promoter, such as 4-pyridinethiol and bis(4-pyridyl)disulfide. The electrode can be used to measure the redox potential of complex mediums without biofouling.

### BACKGROUND OF THE INVENTION

1. Field of the Invention

The present invention generally relates to a universal reduction-oxidation (redox) potential measurement system and electrode, and more particularly, to a device and electrode which can monitor and make precise redox potential measurements in the environment and particularly in the clinically setting such as, for example, measurements made on samples of mammalian tissue, blood, urine, plasma, consates, saliva, extracellular fluid, etc., or measurements made in vivo such as by insertion of an electrode through a catheter for in situ monitoring and by insertion of an electrode through a needle into a tissue.

2. Background Description

Many important biological processes in the body ranging from the state of cellular oxygenation to the overall antioxidant status are directly related to the oxidation-reduction reactions that occur in blood and tissue. Similarly, many important processes that occur in the environment are related to oxidation-reduction reactions. An oxidation-reduction (redox couple) system is composed of two electroactive species which can undergo the following reaction:

O+ne⁻−R

where O is the oxidized form and R is the reduced form of the redox couple and n in the number of electrons (e⁻) transferred during the reaction. At equilibrium the thermodynamic redox potential is related to the concentrations (activities) of O and R by the Nernst equation:

E=E⁰−0.0591/n log(C_{R}/C_{O})

where E is the measured potential, E⁰ is the formal reduction potential of the redox couple, 0.0591 is the value of [2.303(RT/F)] at 25° C. (R is the gas constant and F is Faraday's constant), n is the number of electrons transferred, C_{R} and C_{O} are the concentrations of the reduced and oxidized forms of the redox couple, respectively.

Many investigators have identified that the body's redox potential is related to health and disease. It is also an important measure of environmental conditions in an ecosystem. The redox potential is a measure of the “electron pressure” of a system for exchanging electrons within its environment. Maintaining the correct concentration of electron donors (reductants) and coupled electron acceptors (oxidants) may be essential for cell health (and environmental health). The language of redox balance is not new but has simply not received the attention of that associated with acid-base chemistry. A low E may be associated with a state of respiratory or metabolic redosis. Respiratory causes are due to low PO₂. Metabolic causes include either an increase in nonvolatile reductants or a decrease in nonvolatile oxidants. A high E may be associated with a state of respiratory or metabolic oxidosis. Respiratory causes are due to a high PO₂. Metabolic causes include an increase in nonvolatile oxidants or a decrease in nonvolatile reductants. Thus, tissue oxygenation alone cannot suffice to describe the redox state any more than PCO₂ can describe the acid-base status if HCO³⁻ or pH is not measured as well.

The role of redox balance is likely no less important than that of acid-base chemistry which receives much wider attention and teaching of application. Evidence supports the concept that similar to acid-base ranges, the body operates within a narrow range of redox values which when breached may result in tissue injury at the cellular, subcellular, and molecular level. Several studies have examined the effects of redox potential on organ viability and have demonstrated that a narrow range of redox potential must be maintained to optimize viability. Others have demonstrated that acute systemic injury such as those that occur in hemorrhage results in a significant decrease in blood redox potential that remains depressed even after traditional resuscitation which implies continued cellular dysfunction. Redox potential measures in critically ill patients have demonstrated to be more predictive of the severity of illness and outcome than traditional measures such as simple acid-base status. Although not well studied, the redox status or potential of the wound is also likely to be an important determinant of wound healing.

A much greater emphasis is now being given to the role of redox chemistry in cell signaling of the wound. However, there are no known efforts to make systemic and local wound measurements of overall redox potential as a means to understand acute wound healing and as a potential guide to therapy.

There are a tremendous number of redox systems both intra and extracellularly and the redox potential for many of these systems are known in vitro. Several redox pairs such as lactate/pyruvate can be measured systemically and are indicative of the intracellular redox state. However, focus on individual redox systems may be ill advised at this time given the current knowledge gap in understanding, documenting, and characterizing general clinical redox status of acute illness and injury including wounds. Previous studies have demonstrated that, in sepsis for example, there are decreased circulating concentrations of components of the plasma antioxidant defense system, including beta carotene, selenium, glutathione, glutathione peroxidase, vitamin C and vitamin E. However, contribution to protection from oxidant attack comes also from protein thiols and plasma chelators of free transition metals. Even substances previously thought to be waste products of metabolism, such as urate and bilirubin, may be important in preventing oxidant-mediated injury. Regarding redox systems, blood and the local wound milieu cannot be viewed as a simple chemical and the measurement of individual components is unlikely to yield a complete picture of the in vivo situation.

The redox potential for any tissue or blood as a whole will be determined by the interaction of all redox systems which occur in that milieu. Although more work will need to be done to understand which redox systems are most responsible for change in the redox potential, measurement of the overall redox potential of the system appears to add significant value above and beyond current clinical measures. As stated by Shapiro, it is, in effect not possible to worry about the protons and let the electrons take care of themselves. Developing a means to assess local and systemic redox potential may greatly enhance our ability to monitor tissue health in response to disease and treatment. Currently, however, there are no commercially available technologies that would allow bedside assessment of systemic and local wound redox potential.

There are numerous examples of measuring redox potentials using indicating electrodes since the advent of the glass pH electrode. Examples range from metal electrodes (e.g., gold, mercury, platinum, and silver), to carbon electrodes in their various forms, to selective electrodes composed of glasses, semiconductors, and modified electrode surfaces. In each case, measurements of reversible, Nernstian potentials that convey meaningful analytic information are accompanied by a number of requirements that restrict samples that can be reliably quantified. Among these requirements is the need for fast electron exchange currents between the electrode and the analyte to insure reversible potential measurements, surface chemistry that is constant over time, and the resistance to chemical and physical fouling of the surface.

Potentiometric measurements in biological samples have often failed because of slow electron exchange currents common between metal electrodes and biological redox couples. Indeed, the early workers who sought to measure the formal redox potentials of biological redox couples and electron transfer proteins added reversible couples, e.g., mediators to samples so that reliable potentiometric measurements could be made during redox titrations.

Common potentiometric redox indicating electrodes, such as gold and platinum, are readily fouled and rendered nonresponsive when placed in contact with biological samples. This fouling is caused by the large free energy of adsorption of proteins, peptides, and other biological components at metal surfaces. Historically this problem has been addressed by adding low concentrations of a series of reversible redox mediators that couple the ambient redox potential of biological samples to the potentiometric indicating electrode. This approach is not viable in a clinical setting especially for point of care testing.

There is a need for a potentiometric indicating electrode that remains responsive to the ambient redox potential of biological samples in order to measure respiratory health of an organism. Past work has shown that highly purified redox protein samples do not foul metal electrodes. See, for example, Taniguchi et al., Electrochimica Acta 2000:45-2843-2853, Hawkridge et al., Inorg. Chem. 1995, 17:163-187, and Frew, J. Biochem. 1988:172:261-269. However, when denatured states are present, fouling occurs. Ideally, fouling should be reduced or minimized so that the electron transfer exchange currents remain adequate to permit potentiometric measurements even in these denatured solutions where adsorptive fouling occurs at bare metal surfaces.

### SUMMARY OF THE INVENTION

It is therefore an object of the present invention to provide a universal electrode and system for making redox potential measurements on environmental or biological samples (i.e., samples which contain proteins and other constituents) that is not subject to biofouling and thus permits reliable measurements to be made in clinical or environmental testing applications.

According to the invention, an electrode in the form of a gold wire or plate is chemically cleaned by, for example, immersing in a solution of H₂O₂:H₂SO₄ (3:1 v/v) followed by profusely rinsing with deionized (DI) water. The cleaned gold electrode is then derivatized with an electron-transfer promoter which bonds to and coats the gold and prevents proteins from attaching to the gold electrode, but which promotes electron-transfer in redox reactions to occur quickly and unimpeded. Exemplary promoters include 4-pyridinethiol (4-PySH) and bis(4-pyridyl)disulfide. In one embodiment, the cleaned gold electrode is immersed in an alkaline solution of the promoter (2 mM 4-PySH in 0.1 M KOH) for 30 minutes, followed by profuse rinsing. The derivatized gold electrode is connected to a potentiostat, such as a hand held pH meter, and functions as an indicator electrode. If desired, the gold electrode can be coupled with a reference electrode such as an Ag/AgCl, 3M Cl⁻ reference electrode that is similarly chemically derivatized with the promoter. The resulting potentiometric system can be used to measure the redox potential of a variety of fluids in vivo and ex vivo (e.g., urine, blood, plasma, saliva, extracellular fluid, etc.). The system is “universal” in that it can be used to measure the redox potential of a number of different reactive species, and is not limited to specific enzyme-analyte interactions. In addition, the system performs well in environments where biofouling would otherwise occur.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a schematic of an electron transfer promoter modified gold electrode which can be used as a universal redox electrode according to the invention.

FIG. 2 is a schematic of a universal redox sensor connected to a potentiostat.

FIG. 3 is a graph showing the potentiometric response of various NAD⁺/NADH concentrations as measured by the promoter-modified electrode.

FIG. 4 is a graph showing the redox potential of alkaline and acidic blood measured over 60 minutes using the universal redox sensor.

FIG. 5 is a schematic showing an electrode according to this invention extended into tissue through the cannula of a needle or other introducing element for monitoring of the redox potential of tissues or other samples.

FIG. 6 is a schematic showing an electrode according to this invention inserted through a catheter and extended into a vein or artery for in situ/in vivo redox potential monitoring.

### DETAILED DESCRIPTION OF THE PREFERRED EMBODIMENTS OF THE INVENTION

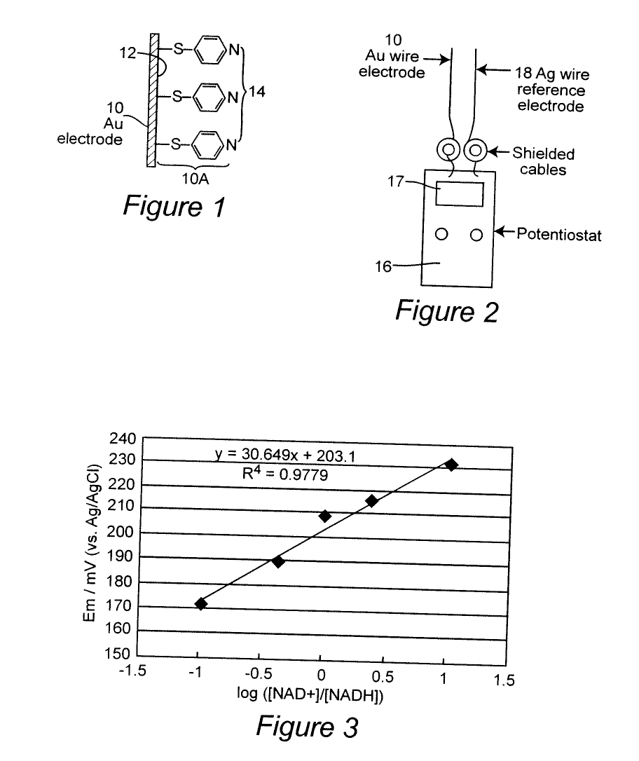

Referring now to the drawings, and more particularly to FIG. 1, there is shown a schematic drawing of a gold electrode 10 which has a surface 12 modified with an electron transfer promoter 14. The electrode 10 can be in the form of a wire, plate, imprint on a ceramic material such as quartz or glass (not shown), or other suitable configuration to allow for ease in making redox potential measurements on biological or environmental fluids or samples. Prior to derivatizing the surface 12 of the gold electrode 10, the electrode 10 is cleaned by, for example, immersing in a solution of H₂O₂:H₂SO₄ (3:1 v/v) followed by profusely rinsing with deionized (DI) water. Other methods of cleaning such as plasma exposure, exposure to different chemicals, exposure to radiant energy, etc., might also be employed. The cleaned gold electrode 10 is then derivatived with the electron-transfer promoter 14. The electron-transfer promoter 14 bonds to and coats the gold electrode 10, and is preferably applied in sufficient quantity so as to prevent proteins from attaching to the gold electrode 10 (FIG. 1 shows, for exemplary purposes, a 10 Å coating on the surface of the gold electrode 10). The electron-transfer promoter 14 functions to promote electron-transfer in redox reactions so that they occur quickly and unimpeded. Exemplary promoters include 4-pyridinethiol (4-PySH) and bis(4-pyridyl)disulfide; however, other chemistries may also preform the functions of preventing biofouling (attachment of enzymes, etc.) and promoting electron-transfer in redox reactions that occur in biological or environmental fluids or tissues. In one embodiment, the cleaned gold electrode is immersed in an alkaline solution of the promoter (2 mM 4-PySH in 0.1 M KOH) for 30 minutes, followed by profuse rinsing.

FIG. 2 shows the derivatized gold electrode 10 connected to a meter 16. The meter 16 functions as a potentiostat and can take a variety of different forms including, for example, a hand held pH meter or other suitable device. The meter 16 is preferably a high impedance meter. The meter 16 may include a display 17; however, any other output device could substitute for the display 17, including a speaker, a printer, or a storage medium which saves the measurements for later analysis. The meter 16 could also be interfaced with other sensors for measuring, for example, pH, oxygen tension, temperature, receptivity, etc., and could output these measurement using the display 17 or other output device. The derivatized gold electrode 10 functions as an indicator electrode. If desired, a reference electrode 18, such as an Ag/AgCl, 3M Cl⁻ reference electrode that is similarly chemically derivatized with the promoter, can be provided. The reference electrode 18 might also be simple platinum or other electrode. Sterilization of the electrodes 10 and 18 can be readily performed by exposure to either UV radiation, ethylene oxide, or some other alternative physical or chemical means for sterilization. The system solves the problems of biofouling that affect conventional metal indicator electrodes.

The potentiometric system (which can also be operated in an amperometric mode) can be used to measure the redox potential of a variety of fluids in vivo and ex vivo (e.g., urine, blood, plasma, condensates, saliva, extracellular fluid, mammalian tissues, etc.). The system is “universal” in that it can be used to measure the redox potential of a number of different reactive species, and is not limited to specific enzyme-analyte interactions. The size of the electrode can vary depending on the application, but will readily lend itself to bedside blood and wound monitoring.

The electrode and system shown and described in FIGS. 1 and 2 was used to measure the redox potential of the quinhydrone redox reaction in phosphate buffered saline solutions. Quinhydrone is known to form a reversible oxidation-reduction couple when dissolved in aqueous solution. Hydrogen ions participate in the reaction between the quinone and hydroquinone (HQ) creating a pH-dependent equilibrium. The redox potential of the resulting equilibrium is proportional to the pH of the solution according to the Nernst equation described above as follows (at 25° C.):

Eₘ=E⁰+0.059/2 log([H⁺]²/[HQ])

where, at 50:50 [H⁺]:[HQ], Eₘ(V)=0.699−0.059×pH
Thus, for this experiment, the quinhydrone added to the test solution serves as both a source of the H⁺ ions and, in combination with an immersed platinum electrode, as a quinhydrone electrode. Therefore, by spiking the phosphate buffered saline solutions with a series of [HQ] ratios and determining the theoretical shift in potentiometric response (ΔE_{theory}) the measured (ΔEₘ) at each quinhydrone redox ratio (slope of Eₘ vs. concentration plot) is compared to ΔE_{theory}. Table 1 shows a comparison of the redox potential measured with the novel electrode with the quinhydrone redox reaction in buffers at pH 4.0 and 7.0 compared to the theoretical redox potential of the quinhydrone redox reaction.

TABLE 1

| | Redox Potential of 4- | |
|---|---|---|
| | PyS-Au\|4-PyS- | |
| | Ag/AgCl Redox | Theoretical Redox |
| | electrode | Potential (25° C.) |
| pH 4.0 | +264.4 mV (±2 mV) | +265.0 mV |
| pH 7.0 | +87.0 mV (±2 mV) | +90.0 mV |

The temperature of solutions for the results in Table 1 was 27° C., and the values of the measured redox potential are expressed as the mean±s.d (n=5). The results in Table 1 indicate significant agreement between the actual measured redox potential and theoretical redox potential at the stated conditions.

To evaluate the potentiometric response of the universal sensor, buffered solutions (pH 7.0) containing varying ratios of the redox couple NAD⁺/NADH were prepared and the redox potential of the couple was measured using the derivatized electrodes discussed in connection with FIGS. 1 and 2. The redox couple is expressed as

NAD⁺+2e⁻+H⁺→NADH

Two electrons are transferred during this redox reaction. From the Nernst equation with n=2, the slope of the plot should theoretically correspond to 29.6 mV at 25° C. FIG. 3 shows a plot of the results for the PyS-Au system. The slope was calculated to be 30.6 mV, which is indicative of Nernstian behavior in the solution containing the redox couple.

The technique of calibrating with the quinhydrone redox couple (of known E⁰ at corresponding pH) was used to effectively determine any deviation of potentiometric response from calculated (theoretical) values in order to quantify the effect, if any, of biofouling on the universal potentiometric sensor when immersed in blood. Specifically, a volume (6.0 mL) of citrated whole pig's blood was placed in a sample vial equipped with a magnetic stirrer without any dilution and allowed to reach ambient temperature. The pH was adjusted to 8.45 using NaOH solution. Another 6.0 mL aliquot of pig's blood was allowed to reach ambient temperature and the pH was adjusted to 6.54 using HCl solution. The pH of the blood was varied in order to create a range of redox potentials. The redox potential for each volume of blood was then measured continuously over course of one hour using the derivatized 4-PyS-Au|4-PyS-Ag/AgCl, 3M Cl⁻ electrodes.

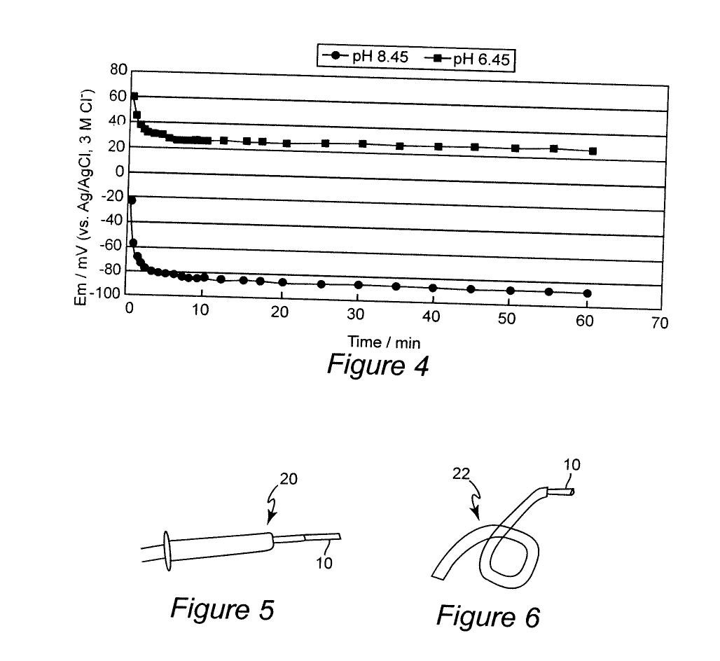

FIG. 4 compares the temporal redox potential of the alkaline and acidic blood as measured using the electrode and system of FIGS. 1 and 2. As shown in FIG. 4, the redox potential is reached within two minutes and is stable over the measured time course of 60 minutes.

In a parallel experiment, the derivatized electrode of FIG. 1 was tested by immersion into a saturated quinhydrone solution at pH 4.0 prior to testing in blood. The electrode was then tested for biofouling by placement in the saturated quinhydrone solution after immersing in blood for 10 min (t=10 min) and after immersing for 1 hour in blood (t=60 min). Table 2 presents the redox potential from this experiment against the theoretical measure. Specifically, Table 2 presents the redox potential of quinhydrone at pH 4.0 as measured by the promoter-modified electrode after various time intervals of immersion in blood.

TABLE 2

| PyS-Au in | | | Theoretical |
|---|---|---|---|
| quinhydrone, | Blood at | Blood at | Redox Potential |
| pH 4.0 | pH 8.45 | pH 6.54 | (25° C.) |
| T = 0 min | +265.0 mV | +265.0 mV | +265.0 mV |
| T = 10 min | +263.5 mV | +262.1 mV | +265.0 mV |
| T = 60 min | +262.4 mV | +260.6 mV | +265.0 mV |

Table 2 shows insignificant biofouling over the course of one hour since there is little fluctuation between the measured and theoretic redox potentials after both rapid and prolonged immersion in blood.

The results presented herein demonstrate that the gold wire electrode system derivatized with an electron transport promoter, such as 4-pyridinethiol, exhibits Nernstian behavior and provides rapid and stable redox measurements of whole blood over a wide range of redox potentials with minimal to no biofouling. The electrode and system can be used for monitoring the redox potential of whole blood from patients. Further, the size of the system and time of response should allow for bedside determination of wound redox potential.

The universal redox system should exhibit Nernstian behavior over a wide concentration range of redox couples (e.g., 10⁻⁴ to 10⁰ M) with low detection limits. It is “universal” in the sense that it is not specific to any particular redox couples (i.e., it does not have a specific enzyme-analyte/substrate activity), and will therefore sense the redox potential as a measure of a biological or environmental sample. Thus, “normal” values for biological samples and environmental samples can be recorded and cataloged, and the effects of treatment or rehabilitative measures can be compared with such normal values. This allows for the development of therapies and rehabilitative measures which heretofore have not existed. The expected response time of the sensor should generally be less than one minute, and the sensor should have life time that exceeds one month.

The electrode's performance and the overall measurement of redox potential can be further improved through several possible calibration schemes. For calibration of an in-dwelling universal redox sensor, one possible strategy may be to use two surface-derivatized gold wire electrodes; a stable redox couple solution entrapped within a swollen, in situ, highly cross-linked hydrogel located directly on one gold wire electrode (electrode A), with the other gold wire (electrode B) functioning as an indicator electrode. Both electrodes can share a common reference electrode, with the three inserted into the tissue. Each electrode can be connected to separate channels on the high-input impedance meter, effectively resulting in a dual channel redox response system. Electrode A's response may then serve as a crude in vivo calibration check. Continuous monitoring of both electrode responses can then be followed for the duration of implantation.

For point of care testing of blood and other fluids or tissues (ex vivo), additional schemes are possible. The evolving field of microfluidics, mechanical drivers, and disposable cartridges would make possible both pre and post-sample redox measurement calibration. For example, a stored solution of quinhydrone on a microfluidic cartridge could be flowed over the electrode for initial calibration. After redox potential measurement of the sample, another pass of quinhydrone solution could be made to help confirm no biofouling had taken place. Alternatively, known concentrations of redox pairs such as NAD/NADH or other could be used in which the concentration of these redox pairs are known to result in an exact redox potential.

An additional method to help ensure absolute measurement of the redox potential could be the passage of a stored dithionite solution over the electrode through the aforementioned microfluidic system. This would be done while the biologic sample is still in contact with the redox electrode. Dithionite is a powerful reducing agent capable of removing all oxygen from the system thus swinging the potential to its maximum negative value. The final redox potential measurement of the biologic sample would thus be the absolute different between the pre-dithionite redox potential and the post-dithionite redox measure. The two microfluidic calibration strategies above are not exhaustive. These same calibration solutions could be contained in small hydrogel complexes which are then chemically or mechanically manipulated to make contact with the electrode.

Lastly, the redox-potential measurement described for herein can be couples with other useful measurements for either in-vivo or point-of-care testing. These additional measurements might include measures of pH, oxygen, temperature, and others which assist in providing information on the overall health of the tissue, blood, and environmental milieu. An example of a combined system might include features of the I-Stat system made by Abbott Laboratories. This system by Abbott also provides an example of what is possible with the combination of microfluidics and cartridge technology. However, the I-State system does not provide for the measurement of redox potential and can be substantially improved by incorporating the invention described herein.

The derivatized electrode itself may be part of the disposable cartridge system and be produced in a manner where, when inserted, one end connects to the potentiostate and the other end is available for interaction with the biologic sample.

Lastly, it is not inconceivable that such a redox system could be miniaturized and implanted in living tissues to continuously monitor the redox state of the body or tissue. The essential elements of the system described herein will be needed including the antibiofouling strategy and some form of calibration strategy.

The electrode and system of this invention may be used for both systemic measurements, thereby allowing for better monitoring of systemic therapies and determining the affect of local or specific redox potential as they pertain to tissue damage and healing monitoring.

Exemplary clinical methods of use include the following:

1) For systemic blood testing, blood will be obtained via peripheral venipuncture at predetermined times. This sample could be placed on a point-of-care cartridge platform as described above for exposure to the redox-electrode for redox potential measurement. Alternatively, the redox electrode could be immersed in a larger sample of blood.
2) A sterilized electrode set will be inserted onto the surface of a wound or tissue (either existing on the patient or surgically created). by insertion of the wire electrode through an occlusive dressing. An additional occlusive dressing will be immediately placed over the electrode. After obtaining a redox potential value, the electrode will be removed along with the occlusive dressings and a new occlusive dressing applied. The electrodes may be placed through a hollow lumen tuber or cannular which is previously placed into the tissue.

FIG. 5 shows an example of an electrode 10 inserted through the cannula 20 of a needle, and FIG. 6 shows an example of an electrode 10 inserted through a catheter 22 (e.g., for in situ monitoring of redox potential in a vein or artery).

While the invention has been described in terms of its preferred embodiments, those skilled in the art will recognize that the invention can be practiced with modification within the spirit and scope of the appended claims.

Having thus described our invention, what we claim as new and desire to secure by Letters Patent is as follows:

1. A reduction-oxidation (redox) measurement system, comprising:
a universal measurement electrode comprised of gold with a surface derivatized with an electron transport promoter in a sufficient quantity to eliminate or reduce effects of biofouling of said surface, said measurement electrode lacking enzymes immobilized on said surface;
a reference electrode; and
a meter connected to said measurement electrode and said reference electrode for measuring the redox potential.

2. The redox measurement system of claim 1 wherein said electron transport promoter is selected from the group consisting of 4-pyridinethiol and bis(4-pyridyl)disulfide.

3. The redox measurement system of claim 1 wherein said reference electrode is surface derivatized with said electron transport promoter.

4. The redox measurement system of claim 1 further comprising a catheter or cannula, and wherein said measurement electrode and said reference electrode extend through said catheter or cannula

5. The redox measurement system of claim 1 wherein said meter is a high-input impedance meter.

6. The redox measurement system of claim 1 wherein said measurement electrode, said reference electrode, and said meter are positioned on an implantable substrate.

7. A non-biofouling electrode for measuring the reduction-oxidation (redox) potential in an environmental or biological sample or tissue consisting essentially of gold with a surface derivatized with an electron transport promoter in a sufficient quantity to eliminate or reduce effects of biofouling of said surface, said measurement electrode lacking enzymes immobilized on said surface.

8. The non-biofouling electrode of claim 7 wherein said electron transport promoter is selected from the group consisting of 4-pyridinethiol and bis(4-pyridyl)disulfide.

9. A method of measuring the reduction-oxidation (redox) potential of a biological or environmental sample, comprising the steps of:
contacting a biological or environmental fluid or tissue with a universal measurement electrode comprised of gold with a surface derivatized with an electron transport promoter in a sufficient quantity to eliminate or reduce effects of biofouling of said surface, said measurement electrode lacking enzymes immobilized on said surface, and a reference electrode; and
using a meter to measure the redox potential at said universal measurement electrode.

10. The method of claim 9 further comprising the step of:
calibrating a redox measurement system which includes said universal measurement electrode and said meter, together with a reference electrode.

11. The method of claim 10 wherein said step of calibrating is performed in vivo.

12. The method of claim 10 wherein said step of calibrating is performed ex vivo.

13. The method of claim 10 wherein said step of calibrating includes the step of contacting said universal measurement electrode and said reference electrode with a solution of known redox potential and using said meter to measure the redox potential at said universal measurement electrode when in contract with said solution of known redox potential.

14. The method of claim 13 wherein said solution of known redox potential is phosphate buffered saline solution or hydrogel of known pH saturated with a known concentration of a redox pair.

15. The method of claim 14 wherein said redox pair includes quinhydrone.

16. The method of claim 14 wherein said redox pair includes NAD/NADH.

17. The method of claim 9 further comprising the step of inserting said measurement electrode and said reference electrode through a catheter.

18. The method of claim 9 further comprising the step of inserting said universal measurement electrode and said reference electrode through a cannula.

19. The method of claim 9 wherein said contacting step includes inserting said universal measurement electrode and said reference electrode into a wound or other tissue in vivo or in situ for continuous or semicontinuous measurement reporting of a redox potential.

20. The method of claim 9 wherein said contacting step includes inserting said measurement electrode and said reference electrode into a vein or artery for continuous or semi-continuous real-time measurement and reporting of a redox potential.

21. A point-of-care system for monitoring patient parameters, comprising:
a reduction-oxidation (redox) measurement system comprising a universal measurement electrode comprised of gold with a surface derivatized with an electron transport promoter in a sufficient quantity to eliminate or reduce effects of biofouling of said surface, said measurement electrode lacking enzymes immobilized on said surface; and
an output device for outputting measured patient parameters.

22. The point-of-care system of claim 21 wherein said output device is a display, a speaker, or a storage device.

23. The point-of-care system of claim 21 further comprising a mechanism for outputting one or more other parameters selected from the group consisting of pH, oxygen tension, temperature, and receptivity.

24. The point-of-care system of claim 21 wherein said universal measurement electrode is disposable and is part of a disposable cartridge system where a first end is associated with a meter and a second end used to contact biological samples, fluids or tissues.

25. A method of measuring the redox potential of a biological or environmental sample, comprising the steps of:
calibrating a reduction-oxidation (redox) measurement system by contacting a universal measurement electrode comprised of gold with a surface derivatized with an electron transport promoter in a sufficient quantity to eliminate or reduce effects of biofouling of said surface, said measurement electrode lacking enzymes immobilized on said surface, and a reference electrode with a phosphate buffered saline solution or hydrogel of known pH saturated with a redox pair of known potential; and
using a high-input impedance meter to measure the redox potential at said measurement electrode when in contact with said phosphate buffered saline solution or hydrogel; and then
contacting a biological or environmental fluid or tissue with said universal measurement electrode and said reference electrode; and
using a high input impedance meter to measure the redox potential at said measurement electrode.

26. The method of claim 25 further comprising the steps of:
exposing the universal measurement electrode to a species which fully reduces the biologic sample; and
measuring a second reading of a redox potential after said step of exposing to said species which fully reduces, and then taking as the final redox potential measurement a difference between the two readings.

27. A method for calibrating an in-dwelling universal reduction-oxidation (redox) sensor, comprising the steps of:
providing two universal measurement electrodes, each comprised of gold with a surface derivatized with an electron transport promoter in a sufficient quantity to eliminate or reduce effects of biofouling of said surface, said measurement electrode lacking enzymes immobilized on said surface;
maintaining a stable redox couple solution entrapped within a swollen, in situ, highly cross-linked hydrogel located directly on a first electrode of said two universal measurement electrodes;
using a second electrode of said two universal measurement electrodes as an indicator electrode;
continuously or periodically monitoring redox measurements with said first and said second electrodes of said two universal measurement electrodes, and using said first of said two universal measurement electrodes as a calibration check of said second of said two universal measurement electrodes.
